(19) United States
(12) Patent Application Publication
(10) Pub. No.: US 2020/0046063 A1
(43) Pub. Date: Feb. 13, 2020

(54) SANDALS CUSTOMIZED FOR A WEARER'S FEET AND METHOD OF MANUFACTURING SAME

(71) Applicant: WIIVV WEARABLES INC., Vancouver (CA)

(72) Inventors: Michael SALMON, Vancouver (CA); Shamil HARGOVAN, Vancouver (CA); Colin LAWSON, Vancouver (CA); Carly FENNELL, Vancouver (CA); Enger BEWZA, Vancouver (CA); Chris BELLAMY, Vancouver (CA); Hannah ZACHRITZ, Vancouver (CA); Carlos MONTALVO, Vancouver (CA); Manuj AGGARWAL, Vancouver (CA)

(73) Assignee: WIIVV WEARABLES INC., Vancouver, BC (CA)

(21) Appl. No.: 16/496,199

(22) PCT Filed: Mar. 22, 2018
(86) PCT No.: PCT/CA2018/000060

§ 371 Date: Sep. 20, 2019

Related U.S. Application Data
(63) Continuation of application No. PCT/CA2017/000166, filed on Jun. 30, 2017.
(60) Provisional application No. 62/475,099, filed on Mar. 22, 2017.

(51) Int. Cl. A43B 3/12; A43B 7/14; A43D 1/02; B33Y 80/00

(52) U.S. Cl. CPC A43B 3/122; B33Y 80/00; A43D 1/02; A43B 7/1465

(57) ABSTRACT

A method for manufacturing a sandal, wherein various aspects of said sandal may be customized for a wearer's feet. The aspects can involve one or more of: the toe thong location, the position of the foot strap, and the arch support profile and arch support position. For a particular wearer, the optimal locations/settings of one or more of the foregoing aspects may be determined by applying a computer algorithm, which takes into account the foot data of the wearer, which foot data may be obtained from image/video capture technology. The method then assembles a sandal having the optimal locations/settings, such that the foot strap position, the arch support profile and/or the arch support position, as the case may be, are customized for the wearer. Also disclosed herein is a sandal having a foot strap position and/or an arch support profile and arch support position that is customized for the wearer, and made in accordance with the above-described methods.

### CROSS-REFERENCE TO RELATED APPLICATIONS

This patent application claims priority from, and incorporates by reference, the entire disclosures of U.S. Provisional Patent Application No. 62/475,099, filed Mar. 22, 2017 and PCT Application No. PCT/CA2017/000166, filed Jun. 30, 2017.

### FIELD OF THE INVENTION

The present invention relates to the field of footwear. More specifically, the present invention relates to the field of sandals or flip-flops, wherein such sandals have certain features that may be customized for a wearer's feet, and a method of manufacturing such sandals.

### BACKGROUND

Sandals or flip-flops (generally referred to herein as sandals) are a popular form of footwear. They are most commonly worn in warm weather, since they allow more ventilation than most other forms of footwear. They are also often selected for wear for various other reasons, for example because they are light, casual in style, convenient to put on, easy to pack, waterproof, etc. Sandals are generally viewed as low cost items; from a manufacturing perspective, they tend to be of simple construction, and tend to be made from low-cost materials such as foam (e.g. ethylene-vinyl acetate foam) and plastic. Like most footwear, a standard construction is adopted with respect to the structural aspects of a pair of sandals, save with adjustments based upon the wearer's actual foot size. From a commercial standpoint, it is not generally contemplated that sandals could be customized for a particular wearer (also sometimes referred to herein as a “user”), especially given sandals' low cost and simple construction. However, given that there can be some considerable variety in terms of shapes, features, and sizes of people's feet, many wearers will find that the standard construction does not suit them even if the foot-size itself is the correct one. This can result in the sandals being ill-fitting or uncomfortable for a specific wearer (which will be exacerbated if the wearer does quite a bit of walking in the sandals and/or plans to wear them often).

A number of aspects for a pair of sandals might benefit from customization for a specific wearer. For example, in the case of a sandal having a toe thong, the actual location of the toe thong could be customized for a specific wearer. (A toe thong as used herein, is also sometimes called a “toe post”, refers to a resilient member that is generally connected to the foot strap of the sandal, and to the sole of the sandal. The base of the toe thong is generally located on the upper sole of the sandal and is proximate to, when the sandal is worn by a wearer, the space between the neck of the wearer's big toe and the neck of the wearer's second toe. When the wearer is wearing and walking in such sandal, the toe thong helps to maintain the position of the sandal relative to the wearer's foot and helps prevent the sandal from falling off the wearer's foot. Further, the wearer may, when necessary, grip the toe thong between his big toe and second toe, so that the sandal does not easily fall off the wearer's foot. In the case of conventional sandals, the toe thong is located at a standard “one-position-fits-all” location. However, given that there can be some considerable variety in terms of shapes, features and sizes of people's feet, a standard toe-thong location can, in many cases, cause discomfort and/or an improper fit.

Another aspect that could be customized for a wearer is the provision of arch support (sandals typically offer little or no arch support for a wearer). A number of people may require or would benefit from footwear which provides arch support, including some people who may have foot, joint, or orthotic issues, or other medical conditions. (In the case of sandals, it is not generally feasible or practical for such wearers to insert orthotic insoles into their sandals, as they might be able to do with their shoes.

Another aspect that could benefit from being customized is the positioning of the sandal's foot strap relative to the wearer's foot. This may be adjusted, for example, by determining where the foot strap is attached to the sides of the sandal, in order to create a better fit.

Accordingly, it could be advantageous to be able to provide a sandal for which certain aspects (such as the location of the toe thong, the positioning of the foot strap, and the degree of and positioning of arch of support) may be customized for a specific wearer. By taking into account various wearer-specific parameters, such as size, shape, thickness and/or profile of the wearer's foot, one would be able to produce a sandal that is more customized for that wearer, thus improving the wearer's comfort and fit. Furthermore, it would be possible to take into account any desired adjustments or biomedical corrections that may be appropriate for such wearer based upon desired corrective measures (e.g. in the case of arch support).

It is contemplated that one could employ various inputs regarding the wearer's foot to facilitate determining preferred/customized settings for the various aspects. For example, this may be achieved via the use of 2-dimensional (2-D) or 3-dimensional (3-D) imaging or via use of a computer vision algorithm based upon 2-D or 3-D foot data, e.g. using a single photograph of the wearer's foot, several photos of the wearer's foot taken from different angles, or a video of the wearer's foot from various angles. It is contemplated that the 2-D or 3-D foot data could be self-generated by a wearer (i.e. by the wearer photographing/capturing his own feet), generated by a device specifically configured for such purpose (e.g. a 2-D/3-D image camera at a kiosk); or generated by a third-party service provider; or provided from the wearer's medical records (e.g. from a podiatrist/chiropodist, including x-ray data). U.S. patent application Ser. No. 15/309,406, filed Dec. 23, 2016, entitled “Generation of 3D-Printed Custom Wearables”, discloses a possible approach for generating custom wearables based upon inputs involving scanning (a body part of the wearer), image processing, machine learning, computer vision, and/or user input, which is incorporated in its entirety herein by reference.

Furthermore, being able to provide such a customized sandal may allow greater options and flexibility regarding the design of sandals; for example, it may be feasible to use stiffer/stronger materials for various parts of the sandal than would otherwise be possible, because of the improved fit and comfort to the wearer.

### BRIEF SUMMARY OF THE INVENTION

Disclosed herein is a sandal for which one or more aspects of the sandal are customized for a wearer's foot. Also disclosed herein is a method for manufacturing such a sandal.

In accordance with one aspect of the present invention, disclosed herein is a method for manufacturing a sandal provided with an arch support that is customized for a wearer, wherein the sandal comprises a foot strap and a sole, the sole having an outstep side and an instep side, the foot strap attached at one end proximate to the instep side of the sole and at the other end proximate to the outstep side of the sole, the method comprising the steps of: (i) acquiring foot data for said wearer; (ii) determining for the wearer, an optimal arch support profile and an optimal arch support position in respect of a given sandal, based upon the foot data for the wearer; (iii) providing an arch support component having a profile that is in accordance with the optimal arch support profile; (iv) providing one or more fasteners configured to fasten the arch support component to the sole of the sandal; (v) providing the component foot strap and sole; (vi) fastening the arch support component to the sole of the sandal at the arch support position using the fasteners; and (vii) assembling the foot strap, the sole and the arch support component together to form the sandal. In some embodiments, the arch support component is fabricated using additive or subtractive manufacturing (3-D printing). In some embodiments, the step of determining an optimal arch support profile and an optimal arch support position may also take into account the specific design of the particular sandal, as well as any desired biomechanical corrections (“orthotic corrections”) that may be applicable for the wearer. In accordance with another aspect of the present invention, also disclosed herein is a sandal made using the foregoing method, and having an arch support customized for a wearer.

In accordance with another aspect of the present invention, disclosed herein is a method for manufacturing a sandal provided with a foot strap position that may be customized for a wearer, wherein the sandal comprises a foot strap, and a sole, wherein the foot strap has an outstep side strap locator and an instep side strap locator, and wherein the sole has an outstep side strap receptor for engaging the outstep side strap locator, and an instep side strap receptor for engaging the instep side strap locator, and wherein each side strap receptor has a plurality of engagement positions for engaging with the respective side strap locators, the method comprising the steps of: (i) acquiring foot data for said wearer; (ii) determining for the wearer, an optimal foot strap position in respect of a given sandal, based upon the foot data for the wearer; (iii) determining an optimal outstep engagement position for the outstep side strap locator to engage with the outstep side strap receptor, and an optimal instep engagement position for the instep side strap locator to engage with the instep side strap receptor, such that the foot strap is positioned in a position corresponding to the optimal foot strap position; (iv) assembling the foot strap and the sole; and (v) securely engaging the outstep side strap locator to the outstep side strap receptor at the optimal outstep engagement position, and securely engaging the instep side strap locator to the instep side strap receptor at the optimal instep engagement position, to form a sandal customized for the wearer. In accordance with another aspect of the present invention, also disclosed herein is a sandal made using the foregoing method, and having a foot strap position customized for a wearer.

In respect of the aspects mentioned above, it is contemplated that the foot data for the wearer may be received through an application programming interface. Further, the foot data for the wearer may be compiled from 2-Dimensional imaging data, 3-Dimensional imaging data, a single photo, multiple photos, and/or a video. In some embodiments, it is contemplated that the foot data for the wearer may be captured through a smartphone, a tablet computer, a camera or a kiosk camera. In some embodiments, the step of receiving the foot data for the wearer, involves previously stored foot data of said wearer.

In accordance with another aspect, disclosed herein is a method for manufacturing a sandal, wherein a plurality of aspects for the sandal (such as toe thong location, foot strap position, and arch support profile and arch support positon) may be customized for the wearer, based upon foot data of the wearer. In another aspect, also disclosed herein is a sandal made using the foregoing method.

### BRIEF DESCRIPTION OF THE DRAWINGS

Embodiments of the present invention are described below with reference to the accompanying drawings in which:

FIG. 1 is a top plan view, illustrating a sandal provided with a customized toe thong location and customized foot strap side strap positions.

FIG. 2 is a side view of the sandal of FIG. 1.

FIG. 3 is a side view of the sandal with the foot strap removed to show the side strap receptor.

FIG. 4 is a representation of the forefoot of a sandal illustrating a custom toe thong insert, and the different positions that the toe thong may be inserted into and engaged with.

FIG. 5 is a perspective view illustrating an embodiment of the custom toe thong insert and the fastener for engaging therewith.

FIG. 6 is a perspective view illustrating the side strap locators and the side strap receptors of the sandal.

FIG. 7 is an exploded view of the midsole of a sandal showing the custom arch support for the sandal.

FIG. 8 is a flowchart which outlines an exemplary method for manufacturing a sandal 10 with a customized toe thong location.

FIG. 9 is a flowchart which outlines an exemplary method for manufacturing a sandal with a customized arch support.

FIG. 10 is a flowchart which outlines an exemplary method for manufacturing a sandal with a customized foot strap position.

### DETAILED DESCRIPTION OF THE INVENTION

The present invention now will be described more fully hereinafter with reference to the accompanying drawing(s), which form a part hereof, and which show, by way of illustration, exemplary embodiments by which the invention may be practiced. The invention may, however, be embodied in many different forms and should not be construed as limited to the embodiments set forth herein; rather, these embodiments are provided so that this disclosure will be thorough and complete, and will fully convey the scope of the invention to those skilled in the art. The following detailed description is, therefore, not to be taken in a limiting sense.

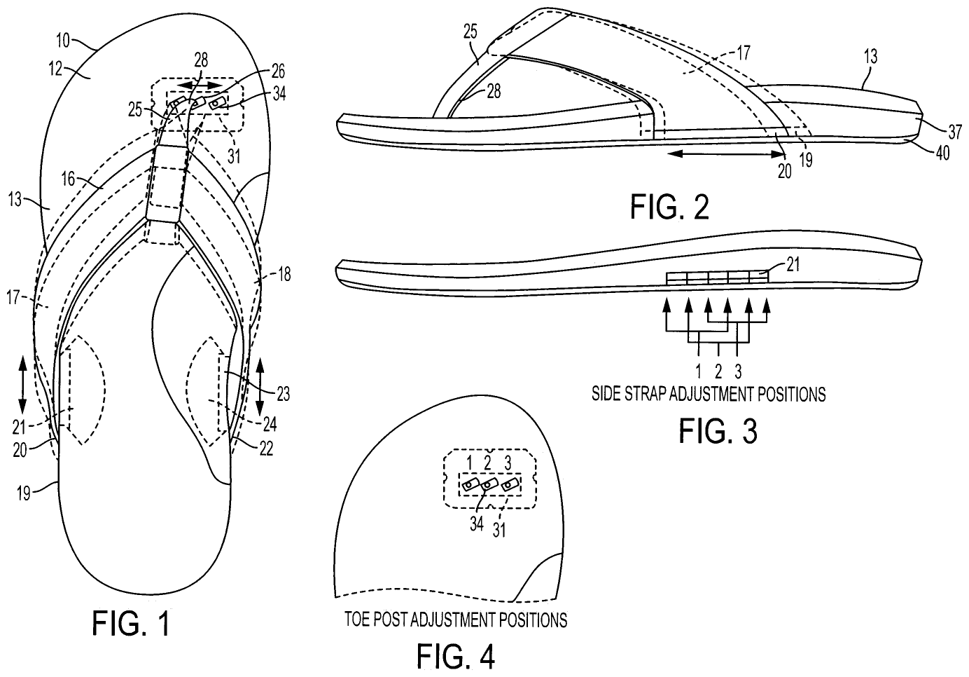

Referring to FIG. 1, a top plan view of a sandal 10 with customized aspects is shown. For ease of discussion, the invention is illustrated herein with reference to customisation of a single sandal in accordance with one foot of a wearer; naturally, in practice, a pair of customized sandals would be manufactured, taking into account both feet of the wearer. The sandal 10 is shown as having a sole 12, a foot strap 16 and a toe thong 25 (although it should be understood that with certain designs of sandals, the sandal may not have a toe thong at all). The sole 12 generally comprises an upper sole 13 (as visible in FIG. 1), a midsole 37 and an outsole 40 (as visible in FIG. 2). The foot strap 16 comprises an outstep strap 17 and an instep strap 18 (typically, the outstep strap 17 and the instep strap 18 are integral with each other). The foot strap 16 is generally attachable to the sole 12 at a location proximate to the outstep or lateral side (sometimes referred to herein as the sandal outstep side 19) of the sandal 10, and at a location proximate to the instep or medial side (sometimes referred to herein as the sandal instep side 22) of the sandal 10. The foot strap 16 is also attached to the toe thong 25 (where the design of the sandal includes a toe thong). (Optionally, the toe thong 25 and the foot strap 16 may be incorporated together). A custom toe thong insert 31 is configured with one or more holes 34. The custom toe thong insert 31 is generally positioned/embedded under the upper sole 13.

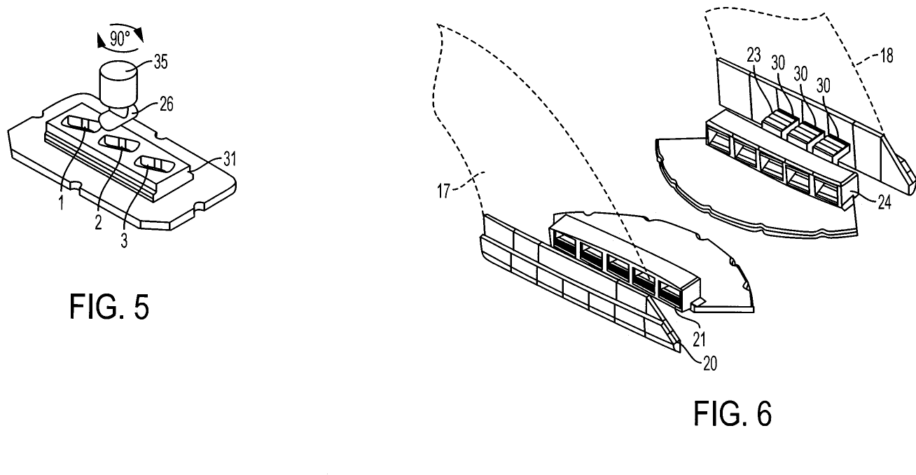

The toe thong 25 is provided with a fastener 26 located at the end of the toe thong 25 that is distal to where the toe thong 25 is attached to the foot strap 16. The fastener 26 may be in the form of a male member which is inserted through a hole in the upper sole 13 and which is configured to be inserted through the hole 34 to securely engage the custom toe thong insert 31. In some embodiments, as shown in FIG. 5, the fastener 26 may be in the form of a rotatable plug, which has a larger profile in one direction and a smaller profile in another direction. In one configuration, the plug presents its smaller profile to the hole 34 so that it can be inserted into the hole 34; when the plug is rotated into a “locked” position, it presents its larger profile, thereby securing the fastener 26 (and the attached toe thong 25) to the hole 34. In an alternative example, the fastener 26 may be in the form of a generally circular plug, which is configured such that it has a greater profile at its back end than at its forward end, so that the plug can be inserted into the hole 34 in a forward direction and “snapped” in place, but is relatively difficult to pull out from the hole in the backward direction once installed.

Solely for purposes of illustration, the custom toe thong insert 31 is shown in FIG. 4, in order to illustrate its actual location within the sole 12 of the sandal 10; it should be noted that when the sandal 10 is fully assembled, the custom toe thong insert 31 is embedded within the sole 12, under the upper sole 13, and is thus not actually visible. FIG. 4 illustrates the custom toe thong insert 31, and how the actual location of the hole 34 may be placed in one of multiple locations (e.g. 1-3). Although in this example, the custom toe thong insert 31 is provided with 3 different positions for the hole 34, all of which are offset along the x-(generally horizontal) direction, it should be understood that the location of the hole 34 may be offset in the y-(generally vertical) direction, or in both the x and y directions. As described below, it is contemplated that, in the manufacturing process for the sandals 10, the custom toe thong insert 31 could be a component that can be fabricated using 3-D printing techniques; as such, there is considerable variation and flexibility in terms of the precise location of the hole 34.

FIG. 5 is a diagram more clearly illustrating an embodiment of the custom toe thong insert 31, and the fastener 26 adapted to engage with said custom toe thong insert 31. The fastener 26 is shown with a rotatable barrel 35 to which the base 28 of the toe thong 25 is attached. The fastener 26 may be inserted into the appropriate hole 34 (having available positions 1-3, as shown), determined to be most suitable for the particular wearer, and rotated into a secured or “locked” position.

FIG. 2 shows a side view of the sandal 10. The sandal is shown with an upper sole 13, a midsole 37 and an outsole 40. The outstep strap 17 of the foot strap 16 is shown attached to the outstep side 19 of the sandal 10.

FIG. 3 shows the sandal 10 without the foot strap 16. Within the midsole 37, on the outstep side 19 of the sandal, is positioned an outstep side strap receptor 21. On the other side of the sandal, on the instep side 22, there is a corresponding instep side strap receptor 24 (not visible in FIG. 3). An outstep side strap locator 20, which is attached to the outstep strap 17 of the foot strap 16, is adapted to engage the outstep side strap receptor 21, thus securing the foot strap 16 to the outstep side 19 of the sandal 10. Similarly, an instep side strap locator 23, which is attached to the instep strap 18 of the foot strap 16, is adapted to engage the instep side strap receptor 24, thus securing the foot strap 16 to the outstep side 19 of the sandal. This is shown more clearly in FIG. 6. The outstep side strap receptor 21 and the instep side strap receptor 24 are generally embedded within the midsole 37, beneath the upper sole 13. A preferred embodiment of the manner in which each side strap locator, 20 and 23, engages with a corresponding side strap receptor, 21 and 24 respectively, is shown in FIG. 6. However, it will be apparent to one skilled in the art that various fastener and engagement mechanisms (e.g. clasps, snap fasteners, studs, screws, etc.) may be utilised. Each side strap locator 20 and 23 comprises one or more side strap fasteners 30. Each side strap receptor 21 and 24 comprises a plurality of engagement positions. For purposes of illustration, in FIG. 3 and FIG. 6, five engagement positions are shown, each configured to receive one of the plurality of side strap fasteners (of which three are shown in FIG. 6). However, it will be understood that the fasteners and receptors may be adapted to provide many more possible engagement positions, in order to allow a higher and finer degree of customization. In the embodiment shown in FIG. 6, each of the plurality of fasteners 30 is configured to matingly engage one of the engagement positions. The fasteners are configured with a number of ridges or “barbs”, which securely engage with corresponding ridges or “barbs” on the engagement position of the side strap receptors 21 or 24; the respective ridges or “barbs” are configured such that the fasteners 30 are relatively easy to insert into the engagement positions in an engagement direction, but difficult to retract extract disengage in the reverse (disengagement) direction. (It will also be apparent to one skilled in the art that the configuration of the respective receptors, 21 and 24, and the fasteners 30 on the locators, 20 and 23, may be interchanged, i.e. such that the direction of mating engagement is reversed). Using the side strap fasteners 30, the side strap locators 20 and 23 securely engage the side strap receptors 21 and 24, so that the foot strap is positioned at a position that is most suitable for the particular wearer, thus producing a sandal having a foot strap position that is customized for the wearer.

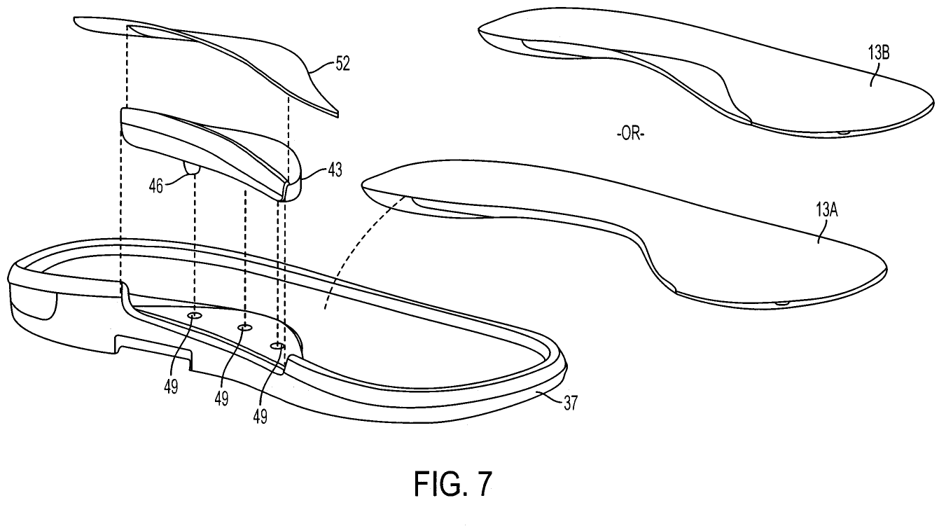

FIG. 7 is an exploded view of the midsole 37 of the sandal showing the custom arch support for the sandal 10. An arch support component 43 is generally located proximate to the instep side 22 of the sandal 10, and may be secured at the appropriate position to the instep side 22 of the midsole 37. The arch support component 43 is secured to the midsole 37 via one or more arch fasteners 46 (which are located on the underside of the arch support component 43) and corresponding fastener receivers 49 (which are configured to receive and engage the arch fasteners 46). Alternatively, the arch fasteners 46 may simply help to secure the arch support component 43 to the midsole 37 (e.g. in combination with adhesives, glues, and other means, as are known in the art). The arch fasteners 46 may be in the form of clasps, snap fasteners, studs, screws, and other such fasteners. It should be understood that one or more of the sets of arch fasteners 46 and fasteners receivers 49 may be switched around, and still work in the same way. The arch support component 43 is configured such that, when it is secured to the midsole 37, it produces a relatively rigid 3-dimensional profile to what would otherwise be essentially a flat surface of the sole 12. This 3-dimensional profile provides the arch support for the wearer, near the location of the instep side 22.

As shown in FIG. 7, the arch support component 43 may optionally be provided with arch cover 52, which is affixed over the arch support component, and generally serves to provide a smooth upper surface. Once the arch support component 43 and arch cover 52 are affixed and secured, an upper sole or footbed 13A is placed over the midsole 37 and affixed. In an alternative embodiment, the arch cover 52 and upper sole/footbed 13 may be integrated with each other, as an integrated arch cover and footbed 13B, as shown in FIG. 7.

It is contemplated that, in the manufacturing process for the sandals 10, the arch support component 43 could be fabricated using a number of manufacturing applications/techniques, such as additive manufacturing (3-D printing), subtractive manufacturing, 2-D printers or laser cutters, etc.; as such, there is considerable variation and flexibility in terms of the precise internal construction of the arch support component 43. Such additive or subtractive manufacturing techniques, and improvements therein, facilitate the large scale, cost-effective and high quality production of sandals with such customized arch supports.

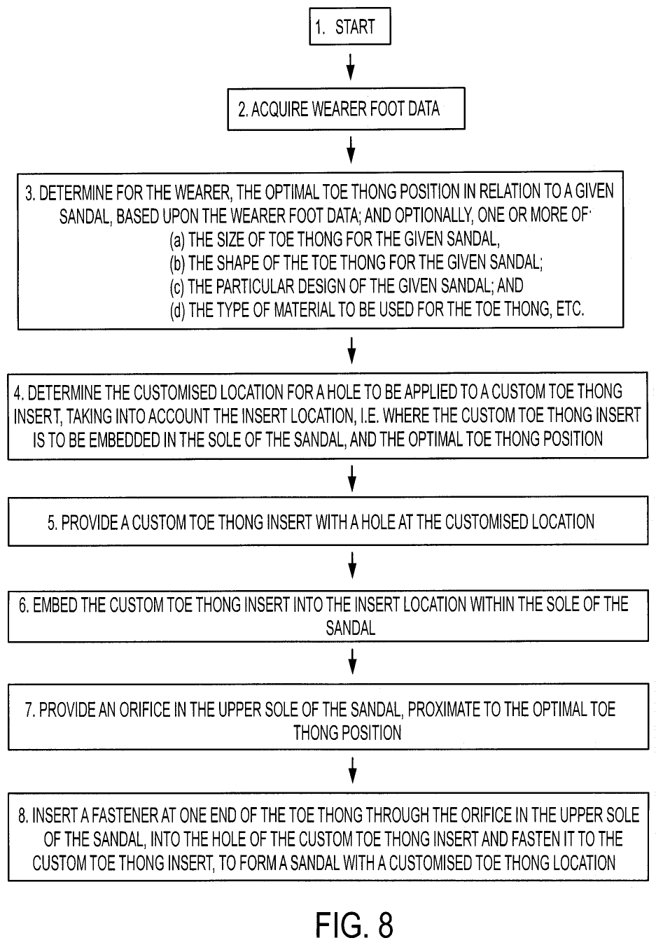

FIG. 8 is a flowchart which outlines an exemplary method for manufacturing a sandal 10 with a customized toe thong location. At step 2, data regarding the wearer's foot/feet (generally referred to herein as foot data) is obtained (step 2). This foot data is generally in a digital or digitizable format. The foot data can take various forms. (U.S. patent application Ser. No. 15/309,406, filed Dec. 23, 2016, entitled “Generation of 3D-Printed Custom Wearables”, discloses a possible approach for generating custom wearables based upon inputs involving scanning (a body part of the wearer), image processing, machine learning, computer vision, and/or user input). This foot data can simply be a photo or such other image capture of the wearer's bare foot (could be a photo of the top or bottom of the wearer's foot) that is taken using an image or video capture device or such other computer vision technology, such as a camera, smartphone or such other dedicated equipment. More usefully, the foot data may comprise several photos taken of the wearer's foot from different views/angles, and optionally in combination with a reference object (e.g. such as a standard size piece of paper). The wearer may be guided to take specific views of the wearer's foot (e.g. a top plan view, a bottom view, a side or front view, etc.). In a preferred embodiment, a dedicated downloadable software application or app may be provided to the wearer and installed on the wearer's mobile device (such as a smartphone) in order to instruct and guide the wearer in taking the appropriate views of his foot.

It is also contemplated, however, that suitable foot data may be obtained by the wearer taking multiple photos of his foot from arbitrary views/angles provided these are sufficiently different to provide sufficient detail regarding the 2-dimensional or 3-dimensional geometry, as the case may be, of the wearer's foot; the processing software can be configured to compile the wearer's foot data from such photos, although this introduces additional complexity from a processing standpoint compared to using specified views.

Alternatively, the foot data may be obtained from a video that is taken of the wearer's foot, again preferably from different views, e.g. by the wearer panning the video/image capture device around the foot. In a further alternative, the historical foot data of the wearer's feet (such as medical records from a podiatrist or chiropodist, or other medical professional, etc. or previously obtained photos/videos) may also be used as the input for the wearer's foot data.

Once the foot data is obtained, the optimal toe thong position for the wearer in respect of a given sandal is determined using a computer algorithm based on the wearer's foot data (step 3). This determination will take into account the shape, size and thickness of the wearer's foot; the size, shape and thickness of the wearer's toe's (particularly of the wearer's big toe and second toe); and the natural spacing between the wearer's big toe and second toe, etc. Optionally, this determination can also take into account one or more of the following, namely: (a) the size of the toe thong for the given sandal; (b) the shape of the toe thong for the given sandal; (c) the particular design of the given sandal; and (d) the type of material to be used for the toe thong. By way of example, where the design of a particular sandal is such that it has a particularly small toe thong, it may be desirable to make an adjustment to the location of the toe thong away from the actual optimal location, to provide the wearer with slightly better grip for the sandal.

The customized location for a hole (of a specified size) 34 to be applied to a custom toe thong insert 31 is determined (step 4), taking into account where the custom toe thong insert 31 is to be embedded in the sole 12 of the particular sandal 10 (sometimes referred to herein as the “insert location”), and the optimal toe thong position determined from step 3. This allows for the hole 34, when the custom toe thong insert 31 in embedded in the sole 12 of the sandal 10 in its predetermined location, to generally correspond to the optimal toe thong position for the wearer.

A custom toe thong insert 31 with a hole (of a specified size) 34 at the customized location is provided (step 5). The hole 34 is generally round, i.e. circular or oval, although other shapes are possible depending on the form of the fastener 26 that is used to engage with the hole 34 and custom toe thong insert 31. The appropriate size of hole 34 may also depend on the type of fastener 26 used. As shown in FIG. 4, the hole 34 for the custom toe thong insert 31 is illustrated as optionally being located in one of 3 different locations 1-3 on the custom toe thong insert 31. For the sake of illustration, it can be determined which of these positions corresponds to (or, if this is not possible, best approximates to) the customized location and to the optimal toe thong position. In the example shown in FIG. 1, the custom toe thong insert 31 is shown with the toe thong 25 inserted into the hole position corresponding to location 2.

During the assembly/manufacturing of the particular sandal 10 (which generally comprises a sole 12 or sandal bed; a foot strap 16 attached to the sole 12 at a instep side 22 and an outstep side 19; and a toe thong 25 attached to the foot strap 16), the appropriate custom toe thong insert 31 is placed in its predetermined position and embedded within the sole 12 or sandal bed (step 6). The custom toe thong insert 31 is preferably embedded in the midsole 37 of the sole 12 of the sandal 10. Although not specifically shown, the midsole 37 may be fabricated with a space for receiving the custom toe thong insert 31, and corresponding to the predetermined position, in order to facilitate the assembly of the sandal 10 and to ensure the correct positioning of the custom toe thong insert 31 during manufacture/assembly of the sandal. Accordingly, the hole 34 is positioned at or proximate to where the base 28 of the toe thong 25 should be located for the wearer.

An orifice is made in the upper sole 13 of the sandal 10, proximate to where the base 28 of the toe thong 25 is to be positioned (step 7)(this also corresponds to the location where the hole 34 in the custom toe thong insert 31 would be located in the assembled sandal 10).

A fastener 26 is provided at the end of the toe thong 25 distal to where the toe thong 25 is attached to the foot strap 16. The fastener 26 is inserted through the orifice in the upper sole 13 of the sandal 10, and into the hole 34 of the custom toe thong insert 31, and securely fastened to the custom toe thong insert 31 (step 8). The base 28 of the toe thong 25 is accordingly positioned at a location corresponding to (or proximate to) the optimal toe thong position. Assembly of the sandal 10 is completed, as may be necessary. In this fashion, a sandal (or more accurately, one foot of a pair of sandals) with a customized toe thong location is manufactured for the wearer. It is contemplated that in the above described process, it is possible to dispense with step 7 by inserting the fastener 26 directly through the upper sole 13 without first making an orifice therein.

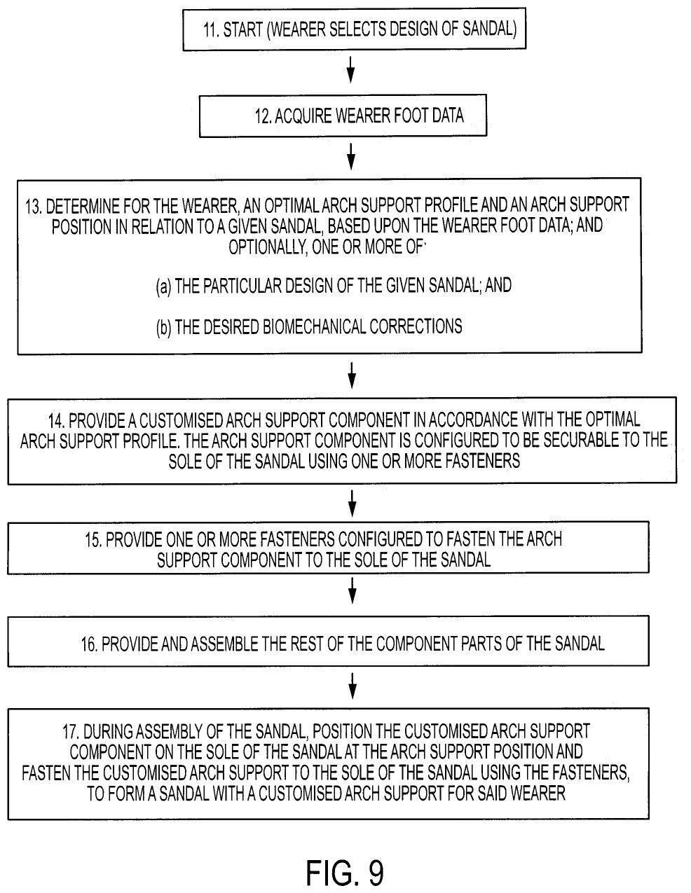

The method described above for manufacturing a sandal having a toe thong location that is customized for the wearer, may similarly be applied to address other customized aspects. In the case of a method for the manufacture of a sandal providing customized arch support for a wearer, FIG. 9 is a flowchart which outlines an exemplary method.

At step 11, a wearer selects a particular design of sandal (or confirms acceptance of such design), and optionally may specify parameters such as colour, graphic design elements to be applied to the sandal, shoe size, etc.

At step 12, the wearer's foot data is acquired. The foot data is generally in a digital or digitizable format, and can take various forms as previously described.

Once the foot data is obtained, it is fed into a customization engine, which is a software based application that applies a set of algorithms to the foot data in order to determine an optimal arch support profile and an arch support position in relation to the given sandal to be manufactured (step 13). This determination may take into account the shape, size, thickness and 3-D profile of the user's foot, etc. In a simplified example, the algorithm can compare the user's foot data with one or more sets of reference foot data, for which the corresponding optimal arch support profile and optimal arch support position has already been determined. The differences between the user's foot data and the reference foot data may be taken into account and the algorithm applies appropriate offset/adjustments to determine the optimal arch support profile and/or optimal arch support position for the specific user.

Optionally, other factors may be taken into account to determine the optimal arch support profile and arch support position. By way of example, further offsets/adjustments can be made depending on certain parameters for the specific sandal being manufactured, such as the physical design (e.g. a sandal design with a relatively thinner sole may not be able to have as thick an arch support profile as a sandal with a relatively thicker sole), the construction materials (e.g. a sandal that is made using relatively stronger materials or that is of a relatively sturdy design, may be better able to support a thicker arch support profile), and the primary function (e.g. a particular sandal that is designed more with comfort/light use in mind, may require relatively slightly less pronounced arch support than say a sandal that is designed to be heavily used for walking). An algorithm can be utilized to apply adjustments or offsets accordingly.

In addition, it is contemplated that where a specific biomechanical or orthotic type of correction is required for the wearer (for example, this may be either as specified by the user, or as may be determined by his foot data or as specified by the wearer's chiropodist/medical professionals), an algorithm can also apply offsets accordingly to determine the optimal arch support profile and arch support position.

A customized arch support component 43 may be fabricated in accordance with the optimal arch support profile (step 14). One or more fasteners 46 may also be fabricated or provided (step 15). In a preferred embodiment, it is contemplated that the arch support component 43 and the fasteners are fabricated using additive (3-D printing) or subtractive manufacturing techniques. In a preferred embodiment, it is also contemplated that the arch support component 43 and the one or more fasteners 46 may be fabricated as an integrated arch support component using such additive or subtractive manufacturing techniques.

The components parts of the sandal (other than the arch support component 43 and the fasteners 46) are fabricated or otherwise prepared (step 16). During the assembly of the particular sandal 10, the appropriate arch support component 43 which is customized for the wearer, is fastened to the sole of the sandal using the fasteners 46 and secured in (or proximate to) the arch support position (step 17). In this fashion, a sandal with an arch support that is customized for the wearer may be manufactured.

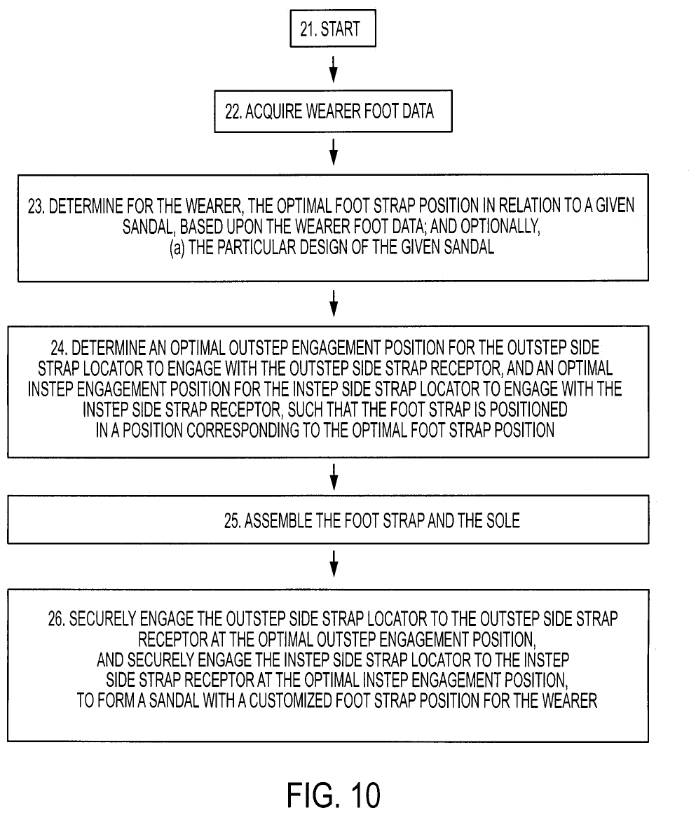

In the case of a method for manufacturing a sandal providing a foot strap position that is customized for a wearer, FIG. 10 is a flowchart which outlines an exemplary such method. At step 22, the foot data for the wearer is acquired. The foot data is generally in a digital or digitizable format, and can take various forms as previously described.

After the foot data is obtained, an optimal foot strap position in respect of a given sandal, is determined for the wearer using a computer algorithm based upon the foot data for the wearer (Step 23). This determination will take into account the shape, size and thickness of the wearer's foot, etc. Optionally, this determination can also take into account the particular design of the given sandal.

Next, the optimal outstep engagement position for the outstep side strap locator 20 to engage with the outstep side strap receptor 21, and an optimal instep engagement position for the instep side strap locator 23 to engage with the instep side strap receptor 24 is determined, such that the foot strap 16 is positioned in a position corresponding to the optimal foot strap position (step 24).

During the assembly of the sandal 10, the outstep side strap locator 20 is securely engaged to the outstep side strap receptor 21 at the optimal outstep engagement position, and the instep side strap locator 23 is securely engaged to the instep side strap receptor 24 at the optimal instep engagement position, to form a sandal having a foot strap location that is customized for the specific wearer.

It will also be apparent to one skilled in the art that the various customizable aspects illustrated in the methods above, may be combined with each other. For example, a method may be applied for manufacturing a sandal in which two or more of the foot strap position, an arch support profile and arch support position, and the toe thong location are customized for a wearer. The customization is based on the wearer's foot data, and optionally other relevant parameters.

1. A method for manufacturing a sandal having an arch support that is customized for a wearer, wherein the sandal comprises a foot strap and a sole, the sole having an outstep side and an instep side, the foot strap attached at one end proximate to the instep side of the sole and at another end proximate to the outstep side of the sole, the method comprising the steps of:
(i) acquiring foot data for said wearer;
(ii) determining for the wearer, an optimal arch support profile and an optimal arch support position, based upon the foot data for the wearer;
(iii) providing an arch support component in accordance with the optimal arch support profile;
(iv) providing one or more fasteners configured to fasten the arch support component to the sole of the sandal;
(v) providing the foot strap and sole;
(vi) fastening the arch support component to the sole of the sandal at the optimal arch support position using the fasteners; and
(vii) assembling the foot strap, the sole and the arch support component together to form the sandal.

2. The method of claim 1, wherein the arch support component is fabricated using additive or subtractive manufacturing.

3. The method of claim 1, wherein the step of determining for the wearer, an optimal arch support profile and an optimal arch support position, is additionally based upon one or more of: a design of the sandal; and a desired biomechanical correction for the wearer.

4. A method for manufacturing a sandal having a foot strap position customized for a wearer, wherein the sandal comprises a foot strap, and a sole, wherein the foot strap has an outstep side strap locator and an instep side strap locator, and wherein the sole has an outstep side strap receptor for engaging the outstep side strap locator, and an instep side strap receptor for engaging the instep side strap locator, and wherein each side strap receptor has a plurality of engagement positions for engaging with the respective side strap locators, the method comprising the steps of:
(i) acquiring foot data for said wearer;
(ii) determining for the wearer, an optimal foot strap position in respect of a given sandal, based upon the foot data for the wearer;
(iii) determining an optimal outstep engagement position for the outstep side strap locator to engage with the outstep side strap receptor, and an optimal instep engagement position for the instep side strap locator to engage with the instep side strap receptor, such that, when the outstep side strap locator and the outstep side strap receptor are engaged with each other and when the instep side strap locator and the instep side strap receptor are engaged with each other, the foot strap is positioned in a position corresponding to the optimal foot strap position;
(iv) assembling the foot strap and the sole; and
(v) securely engaging the outstep side strap locator to the outstep side strap receptor at the optimal outstep engagement position, and securely engaging the instep side strap locator to the instep side strap receptor at the optimal instep engagement position, to form a sandal customized for the wearer.

5. The method of claim 1, wherein the foot data for the wearer is received through an application programming interface.

6. The method of claim 1, wherein the foot data for the wearer is compiled from one or more of 2-Dimensional imaging data, 3-Dimensional imaging data, a single photo, multiple photos, and a video.

7. The method of claim 1, wherein the foot data for the wearer is captured through a smartphone, a tablet computer, a camera or a kiosk camera.

8. The method of claim 1, wherein in the step of receiving the foot data for the wearer, the foot data comprises previously stored foot data of said wearer.

9. A sandal having an arch support that is customized for a wearer, made in accordance with the method of claim 1.

10. A sandal having a foot strap position that is customized for a wearer, made in accordance with the method of claim 4.

11. (canceled)
